(19) United States
(12) Patent Application Publication
(10) Pub. No.: US 2023/0304611 A1
(43) Pub. Date: Sep. 28, 2023

(54) ANTI-HYDROGEN EMBRITTLEMENT WIRE REINFORCED COMPOSITE PIPE

(71) Applicant: ZHEJIANG UNIVERSITY, Hangzhou (CN)

(72) Inventors: Jinyang ZHENG, Hangzhou (CN); Zhongzhen WANG, Hangzhou (CN); Jianfeng SHI, Hangzhou (CN); Riwu YAO, Hangzhou (CN); Zhoutian GE, Hangzhou (CN)

(21) Appl. No.: 18/099,101

(22) Filed: Jan. 19, 2023

Related U.S. Application Data
(63) Continuation of application No. PCT/CN2022/141778, filed on Dec. 26, 2022.

(30) Foreign Application Priority Data
Mar. 24, 2022 (CN) 202210292935.6

(51) Int. Cl. F16L 9/04; F16L 9/12; F17C 13/00

(52) U.S. Cl. CPC F16L 9/042; F16L 9/121; F17C 13/00; F17C 2265/068; F17C 2221/012

(57) ABSTRACT

Method, devices, and systems for transporting high pressure hydrogen over long distance using anti-hydrogen embrittlement wire reinforced composite pipes are provided. In one aspect, an anti-hydrogen embrittlement wire reinforced composite pipe includes a plastic outer layer, a plastic inner layer, and a wire winding layer. The plastic inner layer is provided in the plastic outer layer, and materials of the plastic inner layer and the plastic outer layer are a thermoplastic material. The wire winding layer is provided between the plastic inner layer and the plastic outer layer and bonded with the plastic inner layer and the plastic outer layer by a hot melt adhesive. The wire winding layer is formed by a plurality of wires spirally wound in left rotation or right rotation.

### CROSS REFERENCE TO RELATED APPLICATIONS

This application is a continuation of International Application No. PCT/CN2022/141778, filed on Dec. 26, 2022, which claims priority to Chinese Patent Application No. 202210292935.6 filed on Mar. 24, 2022. The entire contents of these applications are incorporated herein by reference.

### TECHNICAL FIELD

The present disclosure relates to the field of non-metallic pipes, and in particular to anti-hydrogen embrittlement wire reinforced composite pipes and methods for transporting high pressure hydrogen over long-distance using the anti-hydrogen embrittlement wire reinforced composite pipes.

### BACKGROUND

In the whole process of hydrogen energy utilization, hydrogen transport is an important research topic. After the hydrogen energy is produced, the hydrogen energy needs to be transported to hydrogen refueling stations, chemical plants, power stations and other hydrogen-demanding sectors. According to the different states of hydrogen energy transportation, the methods for transporting hydrogen includes gaseous hydrogen transport, liquid hydrogen transport and solid hydrogen transport. Where the high pressure gaseous hydrogen transport is the most mature method for transporting hydrogen, and the high pressure hydrogen can be transported by the pipeline or long-pipe trailer. The pipeline transport is the most economical and energy-saving way to realize large-scale and long-distance hydrogen transport.

There are two main research directions for the pipeline for transporting hydrogen, one is to use the existing natural gas pipeline network for hydrogen blending transport, and the other is to lay pure hydrogen pipeline. The hydrogen blending transport can make use of the existing natural gas pipeline system with low construction cost and can improve the combustion characteristics of natural gas, and currently, the hydrogen transport is mainly based on the existing natural gas pipeline network for hydrogen blending transport. However, the relevant technical mechanism of hydrogen blending transport of natural gas is still unclear, the hydrogen blending separation technology is not mature, and there are safety hazards. The use of pure hydrogen pipelines started in the 1930s and has a long history of development.

Currently, the long-distance pure hydrogen pipeline mainly adopts steel pipes, and materials of the steel pipes include API X42, API X52, API X65 and other typical pipeline steels. The pipeline hydrogen transport requires gaseous hydrogen at high pressure (up to 21 MPa). During high pressure gaseous transport, hydrogen will gradually invade and penetrate steel, and hydrogen embrittlement is caused by hydrogen penetration into steel. As a result, in the mechanical property of steel is decreased, hydrogen cracking and other phenomena can occur. In addition to the occurrence of hydrogen embrittlement, the steel pipe will also be subject to corrosion of the external environment, and the steel is less flexible, It is not only inconvenient for production, transportation and construction, but also difficult to effectively resist the damage caused by earthquakes, mudslides and other natural disasters caused by excessive deformation.

A steel wire reinforced plastic composite pipe is usually used for long-distance transportation of corrosive media such as oil and gas, and includes a steel wire wound plastic composite pipe and a steel wire mesh skeleton plastic composite pipe. The steel wire wound plastic composite pipe is usually based on thermoplastic high-density polyethylene, and reinforced by a steel wire winding layer formed by interlacing and winding at an angle of high-strength steel wire. The steel wire and the polyethylene are bonded with high-performance resin. The mechanism of the steel wire mesh skeleton reinforced pipe is similar to the high-strength steel wire winding reinforced pipe. The thermoplastic high density polyethylene is the base material, and the difference is that the reinforcing layer of the steel wire mesh skeleton reinforced pipe is a welded steel wire mesh. To ensure the strength of the pipe, the steel wire reinforced plastic composite pipe usually requires the use of high-strength steel wire. For example, Chinese patent applications (No. CN113146989A and CN103185177B) disclose a pipe reinforced with a steel wire interlaced and wound and a steel wire mesh skeleton plastic composite pipe in the related art, respectively, and further disclose that the steel wire is made of high-strength steel wire. In the steel wire wound plastic composite pipe, the high-strength steel wire will be affected by hydrogen penetration, which will cause hydrogen embrittlement and affect the strength of the pipe. In the steel wire mesh skeleton plastic composite pipe, the fatigue crack growth rate in the weld area is higher than the base metal, and the welded steel wire is sensitive to hydrogen and more susceptible to hydrogen corrosion, as a result, the strength and stiffness of the steel wire mesh skeleton reinforced pipe will be affected. Therefore, the existing steel wire reinforced plastic composite pipes are not suitable for pure hydrogen transport.

Currently, a high pressure hydrogen transport hose is used in the industry to transport hydrogen over short-distance. The high pressure hydrogen transport hose uses rubber as a pipe lining material. A braided layer of wire or other high-strength fiber is wound outside the rubber lining. For example, Japanese patent applications (No. JP6103088B2 and JP2018066445A) discloses two kinds of hose for transporting high pressure hydrogen, respectively. JP6103088B2 discloses a hose for transporting hydrogen for hydrogen refueling of a fuel cell vehicle. The hose for transporting hydrogen includes an inner layer 2, a reinforcement layer 3, and an outer layer 4. The reinforcement layer 3 includes the first fiber blade layer 3a, the second fiber blade layer 3b, and the third fiber blade layer 3c. The hydrogen pressure is reduced by the construction of multiple reinforcement layers to avoid hydrogen intrusion. The hose performance will not be affected even if the wire M forming the reinforcement layer 3M is hydrogen brittle. The above-mentioned a lining material of the hose for transporting hydrogen includes rubber and other materials with good hydrogen compatibility, such that the performance of the pipeline is almost unaffected by hydrogen intrusion during use, and the rubber material is flexible, thus the hose for transporting high pressure hydrogen is often used in hydrogen refueling stations, hydrogen vehicles and other occasions. However, the diameter of the hose for transporting high pressure hydrogen is very small (less than 32 mm), the flow rate of hydrogen transport is limited, and the cost of the hose for transporting hydrogen is expensive, thus the hose is not suitable for large-scale and long-distance transport of hydrogen.

In summary, currently, the available pipes can not meet the requirements of pipes for transporting hydrogen over long-distance. The transport medium for long-distance pipeline is pure hydrogen or hydrogen doped natural gas, the pipeline is required to be free from hydrogen embrittlement, and can ensure that the pipeline size meets the long-distance and large flow transport requirements. The pipeline shall be flexible to facilitate production, transportation, construction and installation, and the cost of the pipeline shall not be too high.

### SUMMARY

Implementations of the present disclosure provide an anti-hydrogen embrittlement wire reinforced composite pipe and a method for transporting high pressure hydrogen over long-distance using the same to meet the demand for transporting hydrogen over long-distance, which can overcome the defects of the related art described above. Note that, in the present disclosure, the term “long-distance” is a distance considered to be long in the field of high pressure hydrogen transportation. For example, long-distance means a distance greater than a threshold distance, e.g., 5 kilometers (kms). The term “short-distance” means a distance identical to or less than the threshold distance. The terms “long-distance” and “long distance” can be used interchangeably herein.

One aspect of the present disclosure features a method for transporting high pressure hydrogen over long-distance by using an anti-hydrogen embrittlement wire reinforced composite pipe. The anti-hydrogen embrittlement wire reinforced composite pipe includes a plastic outer layer, a plastic inner layer, and a wire winding layer. The plastic inner layer is provided in the plastic outer layer, and materials of the plastic inner layer and the plastic outer layer are a thermoplastic material. The wire winding layer is provided between the plastic inner layer and the plastic outer layer, the wire winding layer is bonded with the plastic inner layer and the plastic outer layer by a hot melt adhesive, and the wire winding layer is formed by a plurality of wires spirally wound in left rotation or right rotation. The wire is at least one of a low carbon steel wire, an aluminum-plated steel wire, a copper-plated steel wire or a stainless steel wire, and the low carbon steel wire has a carbon content of less than 0.25%. The aluminum plated steel wire or the copper-plated steel wire has a thickness of an aluminum or copper layer of 20 μm or more; and the stainless steel wire includes Ni of 10.00% to 14.00%, Cr of 16.00% to 19.00%, and Mo of 1.80% to 2.50%.

Optionally, the materials of the plastic inner layer and the plastic outer layer includes high density polyethylene, and a density of the high-density polyethylene is not less than 0.941 g/cm³.

Optionally, the plastic inner layer and the plastic outer layer have a same thickness.

Optionally, the plastic inner layer and the plastic outer layer have the thickness of at least 3 mm.

Optionally, the wire winding layer is formed by at least two layers of wires interlaced and wound in opposite directions, and the wire winding layer has an even number of layers.

Optionally, the wire winding layer has at least eight wires, and a gap between adjacent wires of the at least eight wires is at least 1 mm.

Optionally, the diameter of the wire is between 0.5 mm and 3 mm.

Optionally, a material of the hot melt adhesive includes modified high density polyethylene.

Optionally, the anti-hydrogen embrittlement wire reinforced composite pipe has a burst pressure exceeding three times the nominal pressure, and the burst pressure of the anti-hydrogen embrittlement wire reinforced composite pipe is determined by formulas including:

$${p}_{B}^{z} = \frac{{Nd}^{2} ( {σ}_{bg} {cos}^{2} α - {σ}_{bp} )}{4 {r}_{i}^{2} cos α} + {σ}_{bp} ( {K}^{2} - 1 ) , and$$

$${p}_{B}^{θ} = \frac{{Nd}^{2} ( {σ}_{bg} {sin}^{2} α - {σ}_{bp} )}{4 {r}_{i} ( {r}_{i} + {r}_{o} ) cos α} + {σ}_{bp} ( K - 1 ) ,$$

where d represents a diameter of the wire, N represents a total number of wound wires, rᵢ represents an inner radius of the composite pipe, rₒ represents an outer radius of the composite pipe, α represents an angle between a winding direction of the wire and an axial direction, K represents a factor (K=rᵢ/rₒ), σ_{bg} represents a strength limit of the wire, σ_{bp} represents a calculated strength of polyethylene, p_{B}^{z} represents an annular burst pressure, p_{B}^{θ} represents an axial burst pressure, and the burst pressure is a minimum of the annular burst pressure p_{B}^{z} and the axial burst pressure p_{B}^{θ}.

Compared with the prior art, the techniques described in the present disclosure produce several technical effects and advantages, some of which are as follows:

(1) The technical means of the present disclosure is to provide an anti-hydrogen embrittlement wire reinforced composite pipe, the high density polyethylene is used as the base material of the composite pipe, the strength of the pipe is improved by the wire interlaced and wound around the outside of the inner layer of polyethylene, and the wire is made of the anti-hydrogen embrittlement steel wire to reduce the influence of hydrogen embrittlement on the mechanical properties of the pipe.

(2) Compared with the conventional steel pipe as a pure hydrogen or natural gas transport pipe, the technical solution of the present disclosure has the advantages of flexibility, hydrogen embrittlement resistance and corrosion resistance, and greatly reduces the cost in the production, transport and construction processes.

(3) The techniques descried in the present disclosure overcome the technical prejudice that the conventional steel wire reinforced plastic composite pipe cannot be used for large-scale and long-distance hydrogen transport. The steel wire reinforced plastic composite pipe tends to use high strength steel wire and steel wire mesh skeleton, which is usually considered as permeable and vulnerable to hydrogen embrittlement and cannot be used for large-scale and long-distance transport of hydrogen. The techniques described in the present disclosure overcome the above technical prejudice by the anti-hydrogen embrittlement wire reinforced composite pipe, which can avoid the influence of hydrogen penetration and hydrogen embrittlement on the mechanical properties of the pipe, and can be used for large-scale and long-distance transport of hydrogen.

### BRIEF DESCRIPTION OF THE DRAWINGS

FIG. 1 is a schematic structural diagram illustrating an anti-hydrogen embrittlement wire reinforced composite pipe according to an embodiment of the present disclosure.

FIG. 2 is a schematic diagram illustrating a change in tensile strength of Q235 steel and 45 steel at different hydrogen concentrations.

FIG. 3 is a schematic diagram illustrating a change in fracture toughness of 316 stainless steel and 304 stainless steel at different hydrogen concentrations.

Reference numerals are listed as follows: plastic outer layer 101; hot melt adhesive binder 102; plastic inner layer 103; and wire winding layer 104.

### DETAILED DESCRIPTION OF THE EMBODIMENTS

The present disclosure is described in further detail below in conjunction with the accompanying drawings.

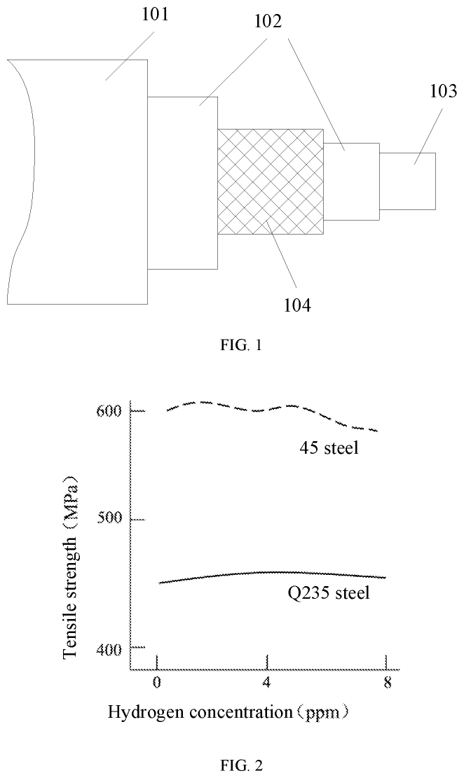

As shown in FIG. 1, an embodiment of the present disclosure provides an anti-hydrogen embrittlement wire reinforced composite pipe including a plastic outer layer 101, a plastic inner layer 103, and a wire winding layer 104. The plastic inner layer 103 is provided in the plastic outer layer 101, and materials of the plastic inner layer 103 and the plastic outer layer 101 are a thermoplastic material. The anti-hydrogen embrittlement wire reinforced composite pipe can be arranged between at least two containers (e.g., hydrogen refueling stations, chemical plants, power stations, or any other hydrogen-demanding sectors) that are separated over a long distance (e.g., more than 5 km) and be configured to transport high pressure hydrogen over the long distance between the at least two containers.

Polyethylene (PE) pipes are widely used in municipal water supply and drainage and gas transport. The maximum working pressure of PE 100 high density polyethylene pipe for transporting city gas is 0.8 MPa and the density is usually no less than 0.941 g/cm³. The hydrogen pressure at an outlet of a hydrogen electrolyzer is usually above 2 MPa, thus the existing polyethylene pipes cannot meet the pressure requirements of the pipe for transporting hydrogen. Unlike metals, high-density polyethylene will not suffer from hydrogen embrittlement. The hydrogen absorbed by high-density polyethylene exists in the form of diatomic molecules and will not be separated as hydrogen does in metals. Therefore, the hydrogen embrittlement resistance of the high density polyethylene can be used for pipes for long-distance transport hydrogen. In an embodiment of the present disclosure, the high density polyethylene is selected as the base material of the plastic inner layer 103 and the plastic outer layer 101. Specifically, the hydrogen permeability of the high density polyethylene is 0.89×10⁻⁹ mol H₂/m·s·MPa.

The strength of the pipe made of the high density polyethylene alone is not sufficient to meet the needs of the pipe for transporting hydrogen, thus, in the present disclosure, a wire is wrapped around the plastic inner layer 103 (as a plastic substrate) formed by the high density polyethylene to increase the strength of the pipe, and after wrapping the wire, the wire and the plastic substrate bear the pressure together, and thus the strength of the pipe is increased after wrapping the wire. Based on a similar principle, for the high-strength steel wire winding reinforced pipe and the wire mesh skeleton reinforced pipe, a reinforced layer is also provided in the thermoplastic inner layer, and through a reasonable pipe design, the high-strength steel wire winding reinforced pipe and the wire mesh skeleton reinforced pipe can bear a pressure of 6.3 MPa or more. In the present disclosure, the wire winding layer 104 is provided between the plastic inner layer 103 and the plastic outer layer 101.

In an embodiment, the plastic inner layer 103 and the plastic outer layer 101 have a same thickness, and the plastic inner layer 103 and the plastic outer layer 101 have the thickness of at least 3 mm to avoid possible instability in the operation of the composite pipe and to prevent excessive thermal effects on the pipe and the reinforcement layer caused by the temperature difference between the inner layer 103 and the outer layer 101 by ensuring the thickness of the plastic inner layer 103 and the plastic outer layer 101.

The plastic layers (the plastic inner layer 103 and the plastic outer layer 101) and the wire winding layer 104 of the composite pipe are bonded by a hot melt adhesive. Since the wire material and the high density polyethylene material of the base material are incompatible, the embodiment of the present disclosure uses the hot melt adhesive to bond the plastic layers 101, 103 and the wire winding layer 104, so that the wire and the high density polyethylene can bear the pressure together, and the advantages of both materials are fully utilized. The hot melt adhesive needs to have excellent bonding performance and barrier performance. A material of the hot melt adhesive can be compatible with a material of the plastic layers. In some examples, the hot melt adhesive can include modified high density polyethylene. The modified high density polyethylene can be obtained by modifying the high density polyethylene to have a sufficient interfacial bonding strength as a hot melt adhesive. In the present disclosure, the wire winding layer 104 is bonded to the plastic inner layer 103 and the plastic outer layer 104 by hot melt adhesive 102, and the wire winding layer 104 is formed by a plurality of wires spirally wound in left rotation or right rotation.

In an embodiment of the present disclosure, the wire winding layer 104 is further optimized, where the wire winding layer 104 is formed by at least two layers of wires interlaced and wound in opposite directions, and the wire winding layer 104 has an even number of layers. The interlacing and winding arrangement of the wire can optimize the stress distribution of the pipe when the pressure is applied to the pipe. A single wire winding layer or each of the at least two layers of wires in this embodiment has at least eight wires, and a gap between adjacent wires of the at least eight wires is at least 1 mm to ensure that the wires are evenly stressed and that the hot melt adhesive can completely wrap the wires through the gaps between the wires to ensure bonding.

As a pipe for transporting hydrogen, the transport medium is pure hydrogen, the pipe shall be resistant to hydrogen embrittlement. Hydrogen penetration to the inside of the pipe will occur during the transportation of hydrogen in the pipe, thus the wound wire in the present disclosure adopts the anti-hydrogen embrittlement steel wire to avoid the phenomenon of hydrogen embrittlement of the wire during the long-term use of the composite pipe and reduce the mechanical properties of the pipe. The hydrogen permeability of high density polyethylene is 0.89×10⁻⁹ mol H₂/m·s·MPa, hydrogen may still slowly penetrate into the plastic base material of the composite pipe, and the metal material of the reinforced layer may be gradually affected by hydrogen corrosion in the long term accumulation of hydrogen transport of the pipe. The inventor found that the low carbon steel wire, the aluminum or copper-plated steel wire, the stainless steel wire has the ability to resist hydrogen embrittlement, and the high strength steel wire has a significant decrease in material mechanical properties after hydrogen corrosion occurs due to its high carbon content.

To this end, by comparing the mechanical properties of different anti-hydrogen embrittlement steel wire materials in hydrogen environment, the present disclosure finally selects three kinds of anti-hydrogen embrittlement steel wires including: (1) a low carbon steel wire, where the low carbon steel wire includes a carbon content of less than 0.25%; (2) an aluminized or copper-plated steel wire, where aluminum or copper is plated on the surface of ordinary high strength steel wire, and the thickness of the aluminized or copper-plated layer is more than 20 μm; (3) a stainless steel wire, where the content of metal elements is controlled in the steel, and the stainless steel wire includes Ni of 10.00% to 14.00%, Cr of 16.00% to 19.00%, and Mo of 1.80% to 2.50%. In addition, considering that the mechanical property of the anti-hydrogen embrittlement steel wire is weaker than that of the ordinary high strength steel wire, the diameter of the wire is between 0.5 mm and 3 mm to ensure the pressure bearing capacity of the wire, so as to avoid the strength failure of the wire.

FIG. 2 is a schematic diagram illustrating a change in tensile strength of Q235 steel (about 0.17%˜0.25% carbon) and 45 steel (about 0.45% carbon) at different hydrogen concentrations, and FIG. 2 shows that the tensile strength of both steels fluctuates as the hydrogen concentration increases. However, the comparison shows that with the increase of hydrogen concentration, the tensile strength of 45 steel fluctuates more, and the difference between the maximum value and the minimum value is 23 MPa, and the difference of Q235 steel is 15 MPa. In the above two steels, the carbon content of Q235 steel is lower, and the higher the carbon content is in the hydrogen environment, the more the mechanical properties of steel will decline, while the mechanical properties of low carbon steel will not decline significantly in the hydrogen environment. Therefore, the low carbon steel with carbon content less than 0.25% can be selected as the material for the anti-hydrogen embrittlement wire in the present disclosure.

In another embodiment, the anti-hydrogen embrittlement wire is made of aluminized or copper-plated steel wire, specifically, aluminum or copper is plated on the surface of ordinary high strength steel wire, and the thickness of the aluminized or copper-plated layer is more than 20 μm. By testing the mechanical properties of aluminized or copper-plated steel wire in a hydrogen environment, the result shows that the aluminized or copper-plated steel wire is virtually unaffected by hydrogen corrosion. The principle is that the aluminized or copper-plated layer can form a protection layer on the steel wire to isolate the hydrogen from penetrating into the steel wire, and thus the aluminized or copper-plated high strength steel wire can be selected as the anti-hydrogen embrittlement wire in the present disclosure. Further, the thickness of the aluminized or copper-plated layer is more than 20 μm to ensure the protective effect of the plating on the steel wire.

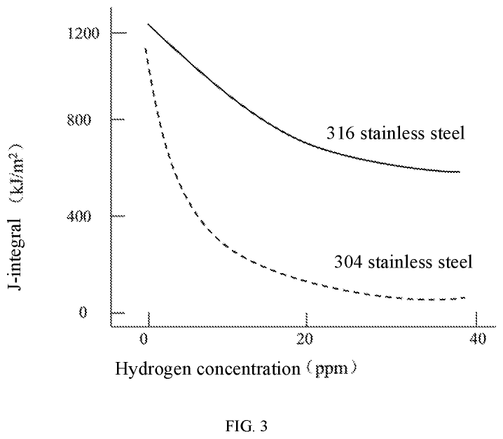

FIG. 3 is a schematic diagram illustrating a change of J-integral for 316 stainless steel and 304 stainless steel at different hydrogen concentrations, and the J-integral is used to characterize the fracture toughness of the material. FIG. 3 shows that the fracture toughness of two steels decreases with increasing the hydrogen concentration, but comparing the two steels, it can be found that the toughness of 304 stainless steel decreases more drastically in the hydrogen environment, while the fracture toughness of 316 stainless steel decreases less. Further, based on the researches by the inventor, hydrogen has an effect on the toughness of stainless steel, and by controlling the content of metal elements in stainless steel, the effect of hydrogen on the mechanical properties of steel can be reduced. For example, the nickel content of stainless steel affects the martensite content of the steel and thus affects the hydrogen embrittlement resistance of the steel. Therefore, the anti-hydrogen embrittlement wire in the present disclosure can be selected from the stainless steel wire with controlled metal content, where Ni content is from 10.00% to 14.00%, Cr content is from 16.00% to 19.00%, and Mo content is from 1.80% to 2.50%.

The application of the anti-hydrogen embrittlement wire reinforced composite pipe of the present disclosure is further described in detail below in conjunction with the actual production and operation scenarios of the pipe for transporting hydrogen.

### Embodiment I

The anti-hydrogen embrittlement wire reinforced composite pipe provided by the present disclosure can be used to construct a long-distance and large-scale hydrogen transmission pipeline system. According to the relevant parameters of the embodiment of the present disclosure, the design dimensions of the composite pipe are obtained as follows. The nominal diameter of the composite pipe is 355 mm, the thickness of the plastic inner layer is 10 mm, the thickness of the plastic outer layer is 10 mm, the high-density polyethylene material of PE100 is used as the base material, and its calculated strength is 25 MPa, and a material of the wire is selected from the aluminized high strength steel wire with a diameter of 1.5 mm, and its lower limit of tensile strength is 1850 MPa. There are four wire winding layers, each of the four wire winding layers has 160 wires, and the angle for winding wire is 30°. The predicted annular burst pressure and axial burst pressure of the composite pipe are calculated by the force balance method. The burst pressure calculation formula can be determined by the following formulas:

$${p}_{B}^{z} = \frac{{Nd}^{2} ( {σ}_{bg} {cos}^{2} α - {σ}_{bp} )}{4 {r}_{i}^{2} cos α} + {σ}_{bp} ( {K}^{2} - 1 ) , and$$

$${p}_{B}^{θ} = \frac{{Nd}^{2} ( {σ}_{bg} {sin}^{2} α - {σ}_{bp} )}{4 {r}_{i} ( {r}_{i} + {r}_{o} ) cos α} + {σ}_{bp} ( K - 1 ) ,$$

where d represents a diameter of the wire, N represents a total number of wound wires, rᵢ represents an inner radius of the composite pipe, rₒ represents an outer radius of the composite pipe, α represents an angle between a winding direction of the wire and an axial direction, K represents a factor (K=rᵢ/rₒ), σ_{bg} represents a strength limit of the wire, and σ_{bp} represents a calculated strength of polyethylene. The annular burst pressure of the composite pipe p_{B}^{z} is calculated to be 30.44 MPa, and the axial burst pressure p_{B}^{θ} is calculated to be 6.78 MPa. The burst pressure is a minimum of the annular burst pressure and the axial burst pressure, and thus the burst pressure of the composite pipe is 6.78 MPa.

The designed service life of the composite pipe is more than 50 years, and the life of the composite pipe cannot be obtained through experimental testing by conventional means, and thus the load distribution of the composite pipe in service can be analyzed to establish the evaluation index of the long-term performance of the composite pipe. During the service process of the composite pipe, the wire reinforcement layer mainly bears the pressure, and the base material will gradually relax with the increase of use time. Therefore, the composite pipe of the present disclosure needs to have a long-term performance prediction method matching its structure. According to the long-term performance analysis of existing composite pipe, a relationship between the long-term performance of the composite pipe of the present disclosure and the short-term test burst pressure can be established, thus the burst pressure of the composite pipe of the present disclosure needs to be more than 3 times of the nominal pressure. If the composite pipe of the present disclosure meets the relationship, the composite pipe has sufficient long-term mechanical performance and can serve for more than 50 years.

The burst pressure of the composite pipe in the embodiment is 6.78 MPa, which is more than three times of the nominal pressure of 2 MPa. Therefore, the composite pipe of the embodiment can meet the demand of long-term hydrogen transport, can replace the metal pipe with the same design requirements, and can undertake the long-term hydrogen transport.

### Embodiment II

The present disclosure can be used to construct an urban hydrogen pipe network system, and the following composite pipe is designed for an urban hydrogen pipe network according to the relevant parameters of the present disclosure. The nominal pressure of the pipe for transporting hydrogen is 2 MPa, and the nominal diameter is a diameter of the typical urban gas pipe, e.g., 160 mm. The relevant dimensions of the designed composite pipe are as follows. The thickness of the plastic inner layer is 10 mm, the thickness of the plastic outer layer is 10 mm, the high-density polyethylene material of PE100 is used as the base material, and its calculated strength is 25 MPa. The material of the wire is low carbon steel wire with a diameter of 1 mm, and its lower limit of tensile strength is 780 MPa. The wire winding layers are formed by two layers of wires interlacing and winding, each of the wire winding layers has 36 wires, and a winding angle is 20°. The annular burst pressure and the axial burst pressure of the composite pipe are calculated by the same force balance method as in the embodiment I. The annular burst pressure of the composite pipe p_{B}^{z} is calculated to be 17.17 MPa, and the axial burst pressure p_{B}^{θ} is calculated to be 6.39 MPa. The burst pressure is a minimum of the annular burst pressure and the axial burst pressure, thus the burst pressure of the composite pipe is 6.39 MPa. which is more than 3 times of the nominal pressure (2 MPa). Therefore, it is considered that the pipe designed by the present can be used to lay the urban hydrogen pipe network system.

It should be noted that the above described are only preferred embodiments of the present disclosure and are not intended to limit the present disclosure. Despite the detailed description of the present disclosure with reference to the above-mentioned embodiments, it is still possible for a person skilled in the art to modify the technical solutions in the above-mentioned embodiments or to make equivalent substitutions for some of the technical features thereof. Any modification, equivalent substitution, improvement, etc. made within the spirit and principles of the present disclosure shall be included in the scope of the present disclosure.

1. A method comprising:
arranging an anti-hydrogen embrittlement wire reinforced composite pipe between two containers that are separated with a long distance greater than a threshold distance; and
transporting high pressure hydrogen over the long distance between the two containers using the anti-hydrogen embrittlement wire reinforced composite pipe,
wherein the anti-hydrogen embrittlement wire reinforced composite pipe comprises a plastic outer layer, a plastic inner layer, and a wire winding layer,
wherein the plastic inner layer is provided in the plastic outer layer, and materials of the plastic inner layer and the plastic outer layer comprise a thermoplastic material, and wherein the wire winding layer is provided between the plastic inner layer and the plastic outer layer and bonded with the plastic inner layer and the plastic outer layer by a hot melt adhesive,
wherein the wire winding layer is formed by a plurality of wires spirally wound in left rotation or right rotation, wherein the wire winding layer is formed by at least two layers of wires interlaced and wound in opposite directions, and the wire winding layer has an even number of layers, and wherein a gap between adjacent wires of the plurality of wires is at least 1 mm,
wherein the plurality of wires comprise a low carbon steel wire that has a carbon content of less than 0.25%, and wherein each of the at least two layers of wires comprises at least eight wires,
wherein a material of the hot melt adhesive comprises modified high density polyethylene, and the hot melt adhesive completely wraps the plurality of wires through gaps between the plurality of wires, and
wherein the anti-hydrogen embrittlement wire reinforced composite pipe has a burst pressure exceeding three times of a nominal pressure for hydrogen transportation, and the burst pressure of the anti-hydrogen embrittlement wire reinforced composite pipe is determined by formulas including:
$${p}_{B}^{z} = \frac{{Nd}^{2} ( {σ}_{bg} {cos}^{2} α - {σ}_{bp} )}{4 {r}_{i}^{2} cos α} + {σ}_{bp} ( {K}^{2} - 1 ) and$$
$${p}_{B}^{θ} = \frac{{Nd}^{2} ( {σ}_{bg} {sin}^{2} α - {σ}_{bp} )}{4 {r}_{i} ( {r}_{i} + {r}_{o} ) cos α} + {σ}_{bp} ( K - 1 ) ,$$
where d represents a diameter of a wire of the plurality of wires, N represents a total number of wound wires, rᵢ represents an inner radius of the anti-hydrogen embrittlement wire reinforced composite pipe, rₒ represents an outer radius of the anti-hydrogen embrittlement wire reinforced composite pipe, α represents an angle between a winding direction of the wire and an axial direction, K represents a factor (K=rᵢ/rₒ), σ_{bg} represents a strength limit of the wire, σ_{bp} represents a calculated strength of polyethylene, p_{B}^{z} represents an annular burst pressure, p_{B}^{θ} represents an axial burst pressure, and the burst pressure is a minimum of the annular burst pressure and the axial burst pressure.

2. The method of claim 1, wherein the materials of the plastic inner layer and the plastic outer layer comprise high density polyethylene, and a density of the high density polyethylene is no less than 0.941 g/cm³.

3. The method of claim 1, wherein the plastic inner layer and the plastic outer layer have a same thickness.

4. The method of claim 3, wherein the plastic inner layer and the plastic outer layer have the thickness of at least 3 mm.

5. The method of claim 1, wherein the diameter of the wire is between 0.5 mm and 3 mm.

6. The method of claim 1, wherein the plurality of wires comprise an aluminized or copper-plated steel wire having an aluminum or copper-plated layer with a thickness more than 20 μm.

7. The method of claim 1, wherein the plurality of wires comprise a stainless steel wire having Ni with a content in a range of 10.00% to 14.00%, Cr with a content in a range of 16.00% to 19.00%, and Mo with a content in a range of 1.80% to 2.50%.

8. An anti-hydrogen embrittlement wire reinforced composite pipe, the composite pipe comprising:
a plastic outer layer;
a plastic inner layer; and
a wire winding layer,
wherein the plastic inner layer is provided in the plastic outer layer, and materials of the plastic inner layer and the plastic outer layer comprise a thermoplastic material,
wherein the wire winding layer is provided between the plastic inner layer and the plastic outer layer and bonded with the plastic inner layer and the plastic outer layer by a hot melt adhesive,
wherein the wire winding layer is formed by a plurality of wires spirally wound in left rotation or right rotation, wherein the wire winding layer is formed by at least two layers of wires interlaced and wound in opposite directions, and the wire winding layer has an even number of layers, and wherein a gap between adjacent wires of the plurality of wires is at least 1 mm,
wherein a material of the hot melt adhesive is compatible with the thermoplastic material, and the hot melt adhesive completely wraps the plurality of wires through gaps between the plurality of wires, and
wherein the composite pipe has a burst pressure exceeding three times of a nominal pressure for hydrogen transportation, and the burst pressure is determined by formulas including:
$${p}_{B}^{z} = \frac{{Nd}^{2} ( {σ}_{bg} {cos}^{2} α - {σ}_{bp} )}{4 {r}_{i}^{2} cos α} + {σ}_{bp} ( {K}^{2} - 1 ) and$$
$${p}_{B}^{θ} = \frac{{Nd}^{2} ( {σ}_{bg} {sin}^{2} α - {σ}_{bp} )}{4 {r}_{i} ( {r}_{i} + {r}_{o} ) cos α} + {σ}_{bp} ( K - 1 ) ,$$
where d represents a diameter of a wire of the plurality of wires, N represents a total number of wound wires, rᵢ represents an inner radius of the composite pipe, rₒ represents an outer radius of the composite pipe, α represents an angle between a winding direction of the wire and an axial direction, K represents a factor (K=rᵢ/rₒ), σ_{bg} represents a strength limit of the wire, σ_{bp} represents a calculated strength of polyethylene, p_{B}^{z} represents an annular burst pressure, p_{B}^{θ} represents an axial burst pressure, and the burst pressure is a minimum of the annular burst pressure and the axial burst pressure.

9. The composite pipe of claim 8, wherein the materials of the plastic inner layer and the plastic outer layer comprise high density polyethylene, and a density of the high-density polyethylene is no less than 0.941 g/cm³.

10. The composite pipe of claim 9, wherein the material of the hot melt adhesive comprises modified high density polyethylene.

11. The composite pipe of claim 8, wherein the plastic inner layer and the plastic outer layer have a same thickness.

12. The composite pipe of claim 11, wherein the plastic inner layer and the plastic outer layer have the thickness of at least 3 mm.

13. The composite pipe of claim 8, wherein the diameter of the wire is between 0.5 mm and 3 mm.

14. The composite pipe of claim 8, wherein the plurality of wires comprise a low carbon steel wire that has a carbon content of less than 0.25%.

15. The composite pipe of claim 8, wherein the plurality of wires comprise an aluminized or copper-plated steel wire having an aluminum or copper-plated layer with a thickness more than 20 μm.

16. The composite pipe of claim 8, wherein the plurality of wires comprise a stainless steel wire having Ni with a content in a range of 10.00% to 14.00%, Cr with a content in a range of 16.00% to 19.00%, and Mo with a content in a range of 1.80% to 2.50%.

17. The composite pipe of claim 8, wherein each of the at least two layers of wires comprises at least eight wires.

18. The composite pipe of claim 8, wherein the nominal pressure is 2 MPa.

19. A hydrogen pipe network system comprising:
at least two containers that are separate with a long distance greater than a threshold distance; and
at least one anti-hydrogen embrittlement wire reinforced composite pipe arranged between the at least two containers and configured to transport high pressure hydrogen between the at least two containers over the long distance,
wherein each of the at least one anti-hydrogen embrittlement wire reinforced composite pipe comprises a plastic outer layer, a plastic inner layer, and a wire winding layer,
wherein the plastic inner layer is provided in the plastic outer layer, and materials of the plastic inner layer and the plastic outer layer comprise a thermoplastic material, and wherein the wire winding layer is provided between the plastic inner layer and the plastic outer layer and bonded with the plastic inner layer and the plastic outer layer by a hot melt adhesive,
wherein the wire winding layer is formed by a plurality of wires spirally wound in left rotation or right rotation, wherein the wire winding layer is formed by at least two layers of wires interlaced and wound in opposite directions, and the wire winding layer has an even number of layers, and wherein a gap between adjacent wires of the plurality of wires is at least 1 mm,
wherein a material of the hot melt adhesive is compatible with the thermoplastic material, and the hot melt adhesive completely wraps the plurality of wires through gaps between the plurality of wires, and
wherein the anti-hydrogen embrittlement wire reinforced composite pipe has a burst pressure exceeding three times of a nominal pressure for hydrogen transportation, and the burst pressure of the anti-hydrogen embrittlement wire reinforced composite pipe is determined by formulas including:
$${p}_{B}^{z} = \frac{{Nd}^{2} ( {σ}_{bg} {cos}^{2} α - {σ}_{bp} )}{4 {r}_{i}^{2} cos α} + {σ}_{bp} ( {K}^{2} - 1 ) and$$
$${p}_{B}^{θ} = \frac{{Nd}^{2} ( {σ}_{bg} {sin}^{2} α - {σ}_{bp} )}{4 {r}_{i} ( {r}_{i} + {r}_{o} ) cos α} + {σ}_{bp} ( K - 1 ) ,$$
where d represents a diameter of a wire of the plurality of wires, N represents a total number of wound wires, rᵢ represents an inner radius of the anti-hydrogen embrittlement wire reinforced composite pipe, rₒ represents an outer radius of the anti-hydrogen embrittlement wire reinforced composite pipe, α represents an angle between a winding direction of the wire and an axial direction, K represents a factor (K=rᵢ/rₒ), σ_{bg} represents a strength limit of the wire, σ_{bp} represents a calculated strength of polyethylene, p_{B}^{z} represents an annular burst pressure, p_{B}^{θ} represents an axial burst pressure, and the burst pressure is a minimum of the annular burst pressure and the axial burst pressure.

20. The hydrogen pipe network system of claim 19, wherein the plurality of wires comprise a low carbon steel wire that has a carbon content of less than 0.25%, and wherein each of the at least two layers of wires comprises at least eight wires.
